(19) United States
(12) Patent Application Publication
(10) Pub. No.: US 2006/0182288 A1
(43) Pub. Date: Aug. 17, 2006

(54) Addressable zone relay method and apparatus

(76) Inventors: Angelo S. Arcaria, Colchester, CT (US); Raymond J. LeBlanc, Bristol, CT (US); Kenneth R. Taylor, Ivoryton, CT (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/119,804

(22) Filed: May 3, 2005

Related U.S. Application Data
(60) Provisional application No. 60/653,093, filed on Feb. 16, 2005.

(51) Int. Cl. H04R 27/00; H04B 3/00

(52) U.S. Cl. 381/82; 381/80

(57) ABSTRACT

An apparatus in a spatially distributed, multicomponent audio system uses an ultrasonic test signal for function assurance. The signal is detected in multiple signal routing devices within the audio system. Each device is equipped with a sensor that detects the test signal. A centralized polling station receives a test report from a device and generates a status report. The testing can be performed at scheduled intervals or by operator command. The results can be displayed graphically where the public address system supports this, and can include alerting processes in event of a fault.

### CROSS-REFERENCE TO RELATED APPLICATIONS

This application claims priority to U.S. non-provisional patent application entitled, “PROGRAMMABLE EVENT DRIVER/INTERFACE APPARATUS AND METHOD,” filed Sep. 22, 2003, having a Ser. No. 10/664,911, the disclosure of which is hereby incorporated by reference in its entirety. This application also claims priority to U.S. provisional patent application entitled, “ADDRESSABLE ZONE RELAY METHOD AND APPARATUS,” filed Feb. 16, 2005, having a Ser. No. 60/653,093, the disclosure of which is hereby incorporated by reference in its entirety.

### FIELD OF THE INVENTION

The present invention relates generally to hardware/software interfaces for control and test of annunciators and loudspeaker devices in public address system equipment. More particularly, the present invention relates to an apparatus and method for testing distributed components of a public address system, and for adding more-refined controls to signal distribution.

### BACKGROUND OF THE INVENTION

In representative industrial and commercial audio announcing systems, loudspeakers and other audio output transducers are typically hard wired, either in parallel or in multiple branches, sometimes referred to as audio loops. These output devices can be driven all at once, or, where specialized or improvised control equipment is used, can be driven separately by audio loop. Such announcing systems can use available public address (PA) systems, annunciator control panels, or personal computer (PC)-based systems as the central control devices. Some PC-based systems may be managed using software controls such as Millennium Event Driver Interface (MEDI™) software. MEDI is an example of a software control that can assign groups of speakers to zones, and, if proper hardware is in place, can activate zones individually.

Some systems based on purpose-built control panels are capable of performing integrity checks, known as supervision, on one or more audio loops by applying a signal across each loop, provided the loop ends in a line termination resistor. If the loop, as tested by a circuit in the control panel, falls within an acceptable range, then the loop is presumed to be intact, whereas if the test result is out of range, the loop is likely shorted or has an open-circuit failure.

Some PC-based and other systems are not capable of performing integrity checks, whether because of added costs associated with hardware and control functions, or because the systems predate such features. Systems capable of detecting basic faults caused by wiring failures in the form of shorts and open circuits may nonetheless not detect faults with high precision. Limited fault detection capability can be further restricted in audio systems into which external amplifiers are incorporated, such as for signal boosting or for expansion of existing systems to support multiple zones. A fault in an external amplifier, for example, can render one or more entire audio loops beyond the amplifier inoperable without providing an operator with a failure report.

Accordingly, it is desirable to provide a method and apparatus that increase public address system controllability and integrity verification test capability.

### SUMMARY OF THE INVENTION

The foregoing needs are met, to a great extent, by the present invention, wherein in one aspect an apparatus is provided that in some embodiments provides a public address system in which an audio test signal at an inaudibly high frequency is transmitted through an amplifier and distributed to one or more addressable zone relay (AZR) devices in the public address system. Each appropriately equipped AZR device serves as a switch apparatus for signal routing and performs one or more tests, both to validate system integrity in part and to detect the test signal. The result of the integrity and signal distribution tests is subsequently returned from the AZR devices by polling to a central control device in the system. In the event that one or more failures are detected in the operation of system, as reported by the AZR device(s), the central control device decodes the polled failure indication(s) and uses one or more annunciatory functions such as graphical screen displays and audible signals to announce the failures.

In accordance with one embodiment of the present invention, an apparatus for generating audible signals from at least one audio transducer is presented. The apparatus includes an electrical load that includes at least one audio transducer, an audio amplifier configured to supply electrical signals having sufficient power to energize the at least one audio transducer, an addressable zone relay configured to control passage of audio information signals from the audio amplifier to the electrical load, an audio control subsystem configured to provide audio signals to the audio amplifier, and further configured to provide bidirectional control communication to and from the addressable zone relay, an audio control subsystem user interface configured to accept commands from a user and further configured to present system status information to a user, and a system monitor function whereby amplifier operability and audio transducer integrity verification functions are performed and presented as components of the system status information.

In accordance with another embodiment of the present invention, a method for generating audible signals from at least one audio transducer is presented. The method for generating audible signals includes generating at least one alternating-current electrical signal for informational message output, wherein the signal includes energy content in an audible frequency range, sensing electrical signal activity, whereby operability of an informational message signal source is confirmed, and redirecting an interconnection path that routes to an audio transducer load a signal, sourced from an amplifier, substituting therefor a test circuit, whereby a load status electrical state is determined at least in part by confirmation of a condition of electrical integrity of the path and the load.

In accordance with yet another embodiment of the present invention, an from at least one audio transducer is presented. The apparatus for generating audible signals includes means for generating at least one alternating-current electrical signal for informational message output, wherein the means for generating furnishes energy content in an audible frequency range, means for sensing electrical signal activity, whereby operability of the means for generating is confirmed, means for transducing an electrical signal into an audio signal, whereby information is broadcast, means for testing the means for transducing, and means for redirecting an interconnection path that routes to the means for transducing a signal, sourced from the means for generating, substituting therefor the means for testing, whereby a load status electrical state is determined at least in part by confirmation of a condition of electrical integrity of the interconnection path and the means for transducing.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating a generic annunciator system with distributed hardware.

FIG. 2 is a block diagram of an annunciator system that incorporates Addressable Zone Relay (AZR) monitoring and zone control capability.

FIG. 3 is a schematic diagram of the microcontroller and receiver section within the AZR of FIG. 2.

FIG. 4 is a relay output section of an embodiment of an AZR sense circuit within the AZR of FIG. 2.

FIG. 5 is a sense circuit section within the AZR of FIG. 2.

FIG. 6 is a software flow chart showing PATS, the additional MEDI software functionality needed to initialize and operate the ultrasonic signal sense circuitry.

FIG. 7 is a software flow chart showing the added MEDI functions needed to perform signal integrity supervision using an AZR in an annunciator system.

### DETAILED DESCRIPTION OF PREFERRED EMBODIMENTS OF THE INVENTION

The invention will now be described with reference to the drawing figures, in which like reference numerals refer to like parts throughout. An embodiment in accordance with the present invention provides control and switch apparatus with test circuitry and associated operational and test support software, the combination of which can perform information signal routing and remote verification of wiring integrity within public address system elements not readily tested using previous apparatus and methods.

The invention presented herein includes, among other elements, a hardware apparatus referred to as an addressable zone relay (AZR). One or more AZRs can be used in conjunction with modified or unmodified millennium event driver interface (MEDI) software in a public address system. AZRs can direct audio signals carrying information such as tone signals, voice messages, radio program material, and the like from an amplifier into at least one output zone, can perform resistive integrity checks on the wiring and electronic devices connected to form the output zones, and can perform signal-detection integrity checks on incoming audio from the amplifier to the AZR. In the embodiments described in greatest detail herein, AZR output zones are tested while public address system signal outputs are disabled. The resistive integrity checks test the condition of end-of-line resistors (R_{EOL}) for load verification. The integrity of the audio input path coming into the AZR from the system master through various amplifiers is verified using pulsed audio tone supervision (PATS) software.

In the AZR applications disclosed herein, PATS-enhanced MEDI software performs control panel functions that cannot be performed from a PC-based or fixed function public address (PA) audio system. When controlled by PATS-enhanced MEDI software, an AZR provides real-time integrity diagnostics of its output zones and further supports real-time verification of audio signals detected on its input from the amplifier. This PATS technique can overcome a lack of built-in integrity checking in some audio amplifiers. Using PATS, integrity checking can be successfully performed on audio amplifiers used in public address and other audio systems.

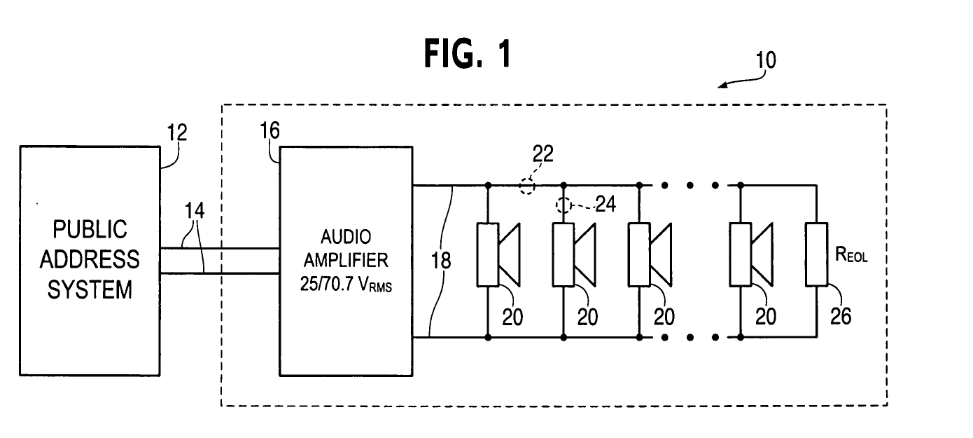

FIG. 1 illustrates a representative prior art wiring application 10, wherein a public address system 12 feeds an audio signal on a signal line 14 to an audio amplifier 16, which amplifier 16 produces a high-level signal output on signal wires 18. The wires 18 may be in the form of a twisted, shielded pair, for example, and are distributed to multiple individual loudspeakers 20. From FIG. 1, it may be seen that a failure such as a wire break at any of locations 14, 22, or 24, a short circuit across any speaker 20, or the occurrence of a fault in an amplifier 16, can impede proper audio output to at least some of the speakers 20 shown.

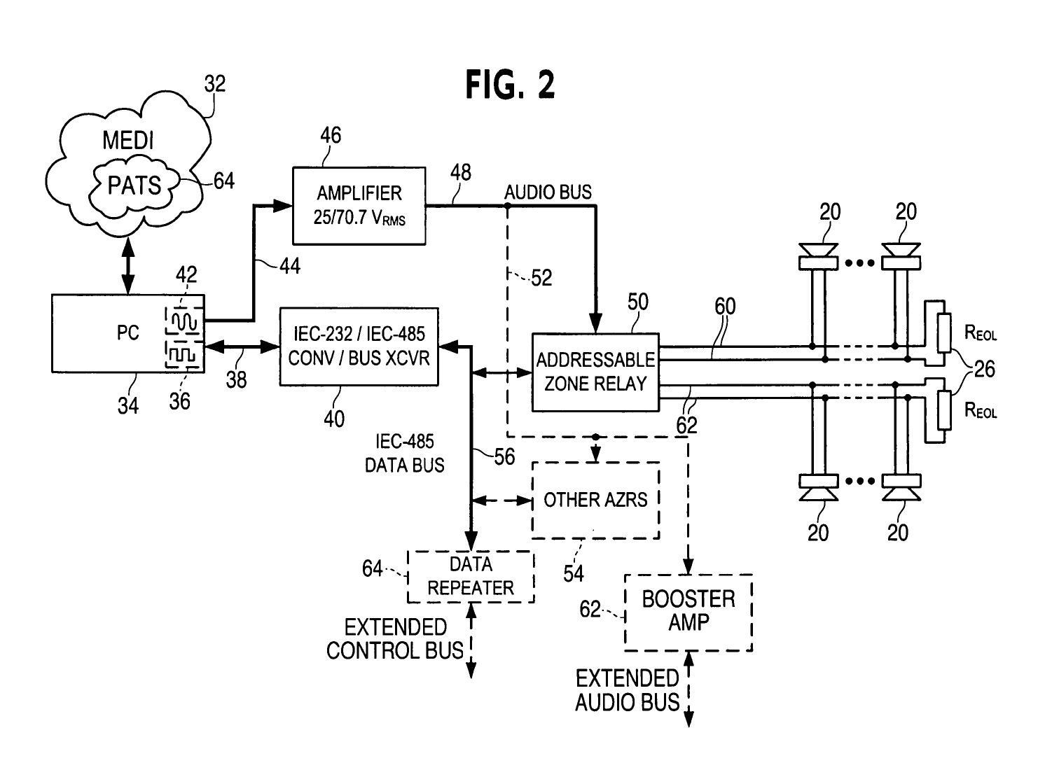

FIG. 2 illustrates, in block diagram form, a PA system 30 including the inventive apparatus and method, in which MEDI control and event software 32 is shown as application software for a general-purpose computing device such as a PC 34. The PC 34 preferably includes a single-ended, bidirectional digital serial port 36 that conforms to International Electrotechnical Commission (IEC) recommended standard (RS) IEC-232. This standard, like IEC-485, discussed below, is substantially adopted from the Electronics Industry Association (EIA) recommended standard with the same number.

In the PA system 30 shown, the serial port 36 provides, via a representative IEC-232-compatible cable 38, a bidirectional interface to an external IEC-232/IEC-485 bidirectional converter device 40, also referred to as a transmitter/receiver or transceiver. In some embodiments, it may be preferable to provide IEC-485 output directly from the PC 34, such as by using an add-in circuit board within the PC 34. While this may change the physical configuration, it can have negligible effect on system operation for some embodiments. Other communication methodologies may be preferable in some embodiments, including the use of bidirectional wireless links to distribute signals between parts of a PA system 30 for which direct wiring may be undesirable.

In addition to the IEC-232 serial port 36, the PC 34 preferably includes an audio output generator 42, which in some embodiments furnishes output at a low signal level, such as 1 V_{RMS} maximum. In the embodiment shown, the PC audio generator 42 uses an external cable 44 to feed a low-level signal to an audio amplifier 46, external to the PC 34. As with the IEC-232/IEC-485 transceiver 40, the audio amplifier 46 may in some embodiments be incorporated within the PC 34. In other embodiments, one or both the audio and transceiver functions may be incorporated within a unit such as an annunciator control panel.

The audio amplifier 46 shown in FIG. 2 is a Standard Audio Amplifier, representative of audio amplifiers incorporated into PA systems, which amplifiers typically provide output signals selectable at 25 V_{RMS} and 70.7 V_{RMS} (nominal full-scale) levels. When used in PA systems such as that in FIG. 1, such an amplifier, shown as reference numeral 16, can be configured for direct distribution of signals to multiple loudspeakers in parallel. In embodiments such as FIG. 2, a comparable amplifier 46 is connected indirectly to loudspeakers 20. Typical loudspeakers, such as reference numerals 20 in FIGS. 1 and 2, are in some embodiments transformer coupled to present relatively high impedance and isolation at least in part with respect to the audio signal distribution wiring (18 in FIGS. 1, 50, and 52 in FIG. 2). In some embodiments, loudspeaker functionality is incorporated in apparatus having additional capabilities, so that a generic term of audio transducer can be preferred. Line termination resistors R_{EOL} 26 can reduce system noise in many configurations, as well as providing manual test support in a prior-art system and automatic test support in a system such as that of FIG. 2.

Instead of directly feeding loudspeakers, as in some prior PA systems, the audio amplifier 46 of FIG. 2 feeds by way of a single two-wire audio distribution line 48 into a first Addressable Zone Relay device (AZR) 50. In the embodiment shown, feed to the AZR 50 can be paralleled by one or more additional audio lines 52 from a tap or other interconnection method connecting the audio amplifier 46 to optional additional AZRs 54. The AZR 50 is also fed by a single two-wire serial digital control line 56, similarly optionally wired 58 using taps or other wiring methods to optional AZRs 54. Two-wire analog output lines from the first AZR 50 form a first and a second speaker loop 60 and 62, respectively. Each of the analog and digital input and output lines may in some embodiments use twisted pair and/or shielded conductors. Subsequent discussion herein addresses primarily a single AZR 50 system, with the understanding that operation of a multiple-AZR system and of AZRs with other than two speaker output loops is substantially identical except as noted.

At the system configuration level, multiple AZRs can be wired in parallel, using, in some embodiments, control line taps 58 off common lines, as shown in FIG. 2. Multiple audio amplifiers such as booster amplifiers 68 may be optionally employed, using, for example, the high-level output of the first audio amplifier 46 as the input to each booster. It is to be understood that substantially all of the energy applied to all speakers 20 in typical system embodiments using one or more AZRs 50 is provided by one or more audio amplifiers 46, while the AZRs 50 are used for control functions such as signal routing, and for system status monitoring. Alternate AZR configurations, in which one or more of the functions of an AZR 50 are incorporated into an apparatus that also includes an audio amplifier 46, may be preferable for some embodiments.

The MEDI control software 32 operates within the PC 34 to provide event data and control—that is, messages such as status inquiries, configuration instructions, activation commands or events, and the like—to PA system components including one or more AZRs 50. MEDI 32 incorporates the Pulsed Audio Tone Supervision (PATS) function 64 to perform integrity validation from the PC audio generator 42, through the audio amplifier 46, to a detector within the AZR 50. MEDI 32 further provides in a video screen display a text and/or graphical representation of system status, including fault conditions, and can additionally include capabilities such as audible signals and enhanced graphical indications to announce fault events, whereby prompt attention to faults can be sought.

In the embodiment shown, PATS 64 generates an ultrasonic signal—a tone at a frequency above the human audible range—with a specific envelope, using the PC 34 audio generator function 42. In some embodiments, a data file providing a point-by-point digitized voltage waveform is retrieved from system memory and sent to the PC audio generator 42, which converts the data file to an electrical signal having substantially the original frequency and having amplitude appropriate for input to an amplifier 46. If the tone so generated falls within the operating frequency range of typical audio amplifier apparatus, it can be amplified by the amplifier 46, propagated throughout the system, and sensed in one or more AZRs 50 to verify system integrity.

Because the PATS 64 signal is ultrasonic, the broadcast is not typically noticeable in locations where the usual audio output of the same PA system is readily heard. For example, a tone around 25 KHz, which is somewhat above the nominal human limit, may in some embodiments be somewhat distorted by an amplifier 46 and speakers 20, but typical distortion products are even higher in frequency, and thus further beyond the audible range. A typical PC audio generator 42 and a typical amplifier 46 may each exhibit rolloff above the audible range, so that the amplitude of a realized ultrasonic signal from a given computed waveform amplitude may be less than the realized amplitude of a comparable audible-range signal, but rolloff is in many cases sufficiently gradual to permit operation at desirable PATS 64 frequencies. If a PATS 64 signal at a frequency some octaves further above the audio range were used, such as 200 KHz, for example, output amplitude rolloff could be more affected by PC audio generator 42 characteristics and by a user's choice of amplifier 46.

In some embodiments, the amplitude of the PATS 64-generated signal can, if applied as a “boxcar” function, so that the signal amplitude slews at maximum rate from no output to full output and vice versa, cause a detectable “pop” sound at the beginning and end of an otherwise inaudible ultrasonic tone. Other waveform envelopes, such as a ramp up/hold/ramp down amplitude envelope, can allow the PATS 64 function to operate substantially free of audible artifacts.

A criterion of functionality is the active area bounded by the envelope—that is, the integral of signal power over time to yield the applied energy of the PATS 64 signal. This energy value determines in part the effectiveness of the detector circuit.

The PATS 64 ultrasonic signal can coincide with an audible event signal such as a tone or a voice announcement, but the effect of such an occurrence is largely unnoticeable in many embodiments. If transmitted during a period when the public address system is silent, the PATS 64 signal is substantially transparent to system function. For example, the PATS 64 signal may be in progress when, or may begin while, an event occurs. Typical audio devices such as an audio generator 42 within a PC 34 can support asynchronous application of multiple waveform data files, with the sound output circuit of the generator 42 summing the waveforms. The ultrasonic component of speaker 20 output can in general exhibit negligible effect on the perceived sound from an AZR-equipped PA system 30.

As many as sixty-four AZRs 50 are individually addressable in the embodiment shown. The signal strength fanout limitations of the IEC-485 standard reduce to thirty-two the maximum number of AZRs 50 in a fully compliant system in which no IEC-485 repeaters are used, so a maximized system could require at least one bidirectional IEC-485 data repeater 66. Excessive line lengths and the inclusion of other loads on the command bus 56 may similarly limit the maximum fanout under IEC-485.

The bidirectional IEC-232/IEC-485 converter 40 is used to convert between the IEC-232 single-ended serial communication on the PC 34 side and IEC-485 differential serial communication on the AZR 50 side. Each AZR 50 in embodiments such as those shown has an IEC-485 data port to allow the AZR 50 to receive commands from and transmit replies to the MEDI software 32. Events and polling commands are transmitted by the PC 34 using the existing MEDI 32 command structure, as described in detail in U.S. patent application Ser. No. 10/664,911, filed Sep. 22, 2003, and incorporated herein in its entirety by reference.

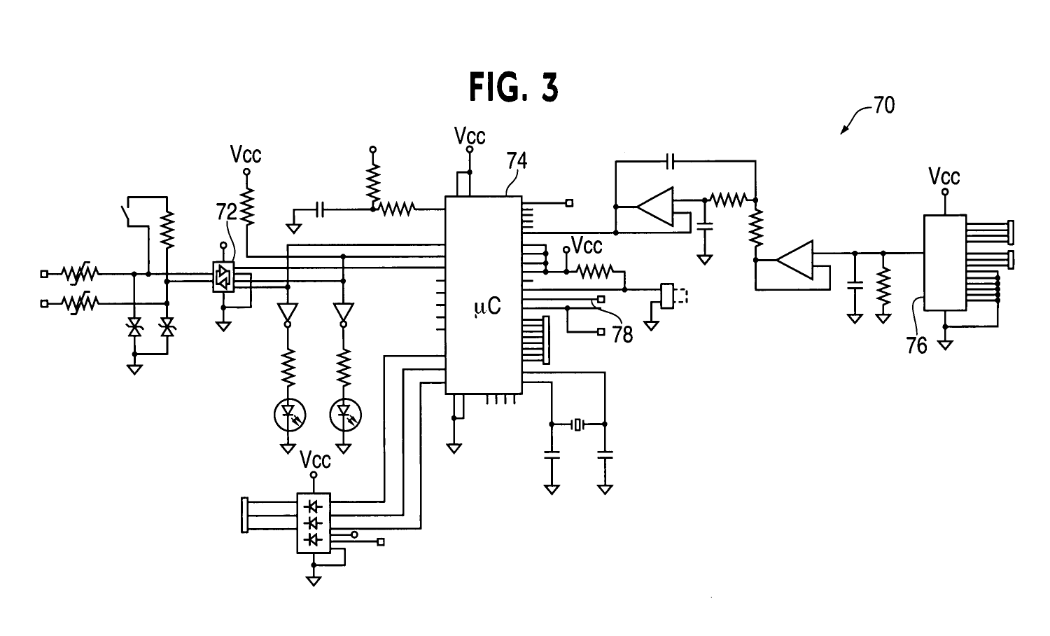

FIG. 3 shows a section of a schematic diagram 70 of a microcontroller and digital command receiver for an AZR 50 design, as discussed in greater detail below.

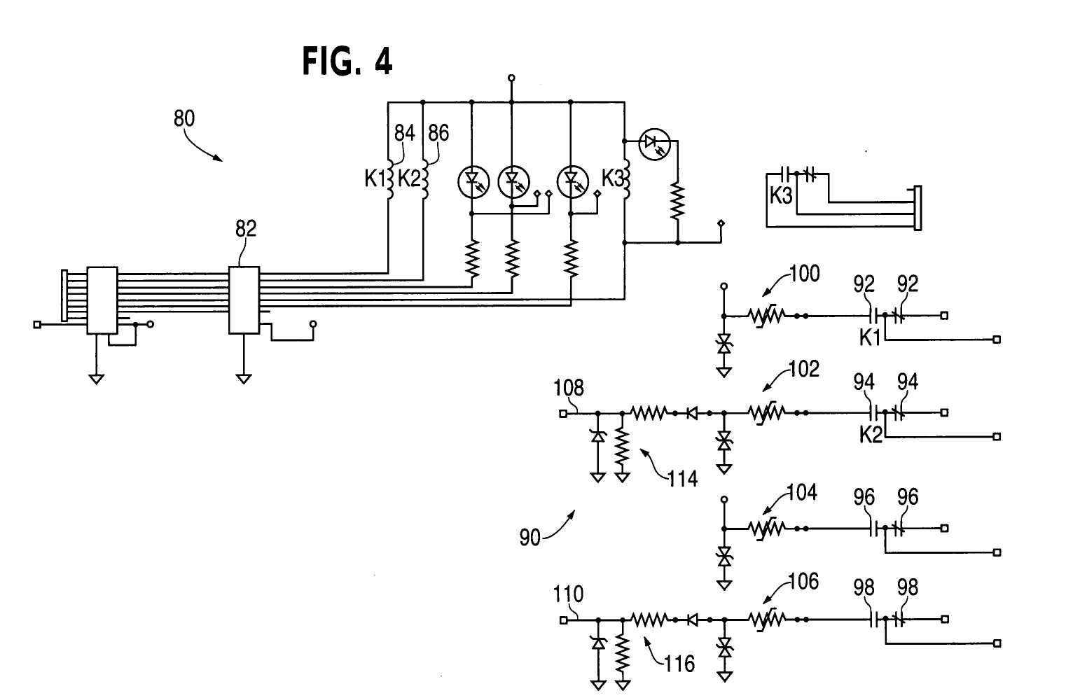

FIG. 4 shows a section of a schematic diagram 80 of an output relay driver 82 that drives a first AZR speaker loop relay 84 and a second AZR speaker loop relay 86. The AZR 50 in the embodiment shown provides an addressable, fail-safe dual relay function between the audio amplifier 46 and the first and second speaker loops 60 and 62, respectively, shown in FIG. 2. As applied herein, the term “fail-safe” means that amplifier signals connect from AZR input terminals through the normally-closed and common contacts in the relays 84 and 86 via interconnection elements (such as wiring, connector pins, terminals, and the like) to the AZR 50 output terminals to speaker loads such as the output lines 60 and 62. As a result, when the AZR 50 is unpowered, connection is made between the amplifier 46 and the speakers 20 in FIG. 2. This assures connectivity between the amplifier 46 and the speakers 20 in event of most AZR 50 functional failures and in event of loss of AZR 50 premises power.

FIG. 4 further shows the relay output section 90 of the AZR 50, in which the normally open/normally closed (NO/NC) contact sets 92, 94, 96, and 98 of the AZR output relays 84 and 86 are shown, along with overload protection circuits 100, 102, 104, and 106, and monitor (“SUPRV_{—}1” and “SUPRV_{—}2”) circuits 108 and 110. The monitor circuits 108 and 110 feed an analog input multiplexer 76, shown in FIG. 3. The multiplexer 66 provides signal steering for the monitor circuits 108 and 110 and other inputs to the AZR microcontroller 74.

It is to be understood that the term “relay” as used herein refers to a monostable electromechanical switch device with a single electromagnetic actuator that can be caused to move to an active state with application of input power. When activated, the switch device changes the state of any component switch contacts from a deenergized state, in which any “normally closed” contacts are connected to “common” contacts, to an energized state, in which any “normally open” contacts are connected to the common contacts instead. Deenergizing such a device restores the original contact status, unlike magnetic latching relay types, which lack an intrinsic fail-safe characteristic. Relays used in electronic circuits can require drivers 82, which may be simple bipolar transistors, power field effect transistors (FETs), or other devices as determined by the power required to cause a particular style of relay to actuate. So-called solid state relays and devices such as FETs themselves can be used as isolated switch devices in place of electromechanical relays in some applications, and can exhibit fail-safe functionality in some embodiments.

A typical AZR 50 may be configured to accept a total of 250 watts of audio signal power, divided between two output speaker loops, so that 125 watts is available to each of two speaker loops. In some embodiments, the relays 84 and 86 can each carry the full 250 watts, so their need be no constraint on assigning loads to AZR 50 outputs. In other AZR 50 configurations, additional relays may be incorporated into the AZR 50, so that an increased number of branches may be provided, either by reducing the power to each branch or by increasing the amplifier 46 output capability.

Each relay output, shown deenergized, connects a signal from the common input to one of the AZR 50 outputs. When the relay coils 84 and 86 for relays K₁ and K₂, respectively, are energized, the input is disconnected from the outputs, while test circuits 108 and 110, respectively, apply an AZR 50 internally-regulated source voltage through the end-of-line resistors R_{EOL} 26 shown in FIG. 2, then through voltage dividers 114 and 116 to generate test voltages with known ranges, detectable by an analog-to-digital converter function within a microcontroller 74, shown in FIG. 3. Over- and under-voltage signals suggest short and open circuits. Connection to potentially destructive voltages, such as premises 120 VAC, can cause the protection circuits 100, 102, 104, and 106 to disable connection to the speaker lines, protecting the AZR 50 while producing an anomalous measurement. Where a relay output to speakers is split into a plurality of wiring paths, each wiring path can be terminated in an end of line resistor R_{EOL} 26, where the effective termination values (including speaker loads) are preferably similar or related in value in order to have an as-assembled parallel value roughly comparable to that of a single end-of-line resistor. This permits a failure such as a broken wire in one of the plurality of wiring paths to produce a detectable error symptom, so that testability is comparable to that of a unified wiring path.

Control of the relays 84 and 86 in the embodiment shown is performed by the microcontroller 74, shown in FIG. 3, using embedded firmware in the microcontroller 74, equivalent executable software stored outside the microcontroller 74, downloaded code for a field programmable gate array (FPGA), or the like. The functions performed by the microcontroller 74 are substantially identical to those performed by satellite microcontrollers described in U.S. patent application Ser. No. 10/664,911, to which are added actuation and deactuation functions for the AZR relays 84 and 86, analog sense measurements and test result storage for the speaker loops with the relays 84 and 86 actuated, and a sense-and-store function for the PATS signal level detector 122, described next.

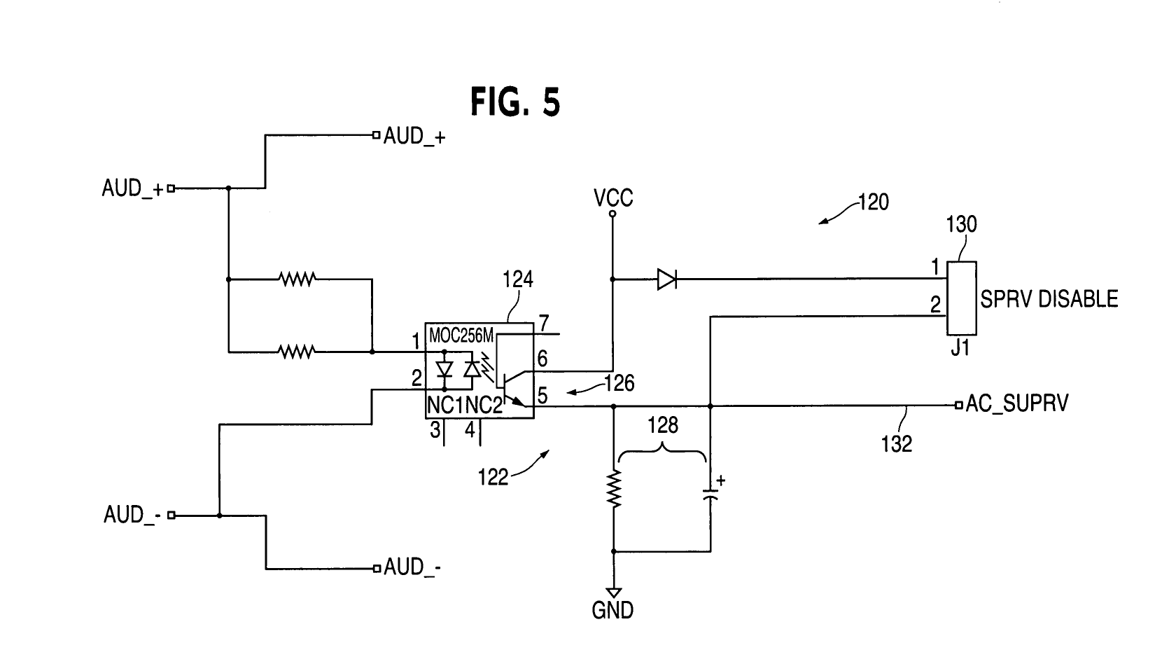

FIG. 5 shows a schematic diagram 120 of an audio detector circuit 122 in the AZR 50, shown in FIG. 2. MEDI 32 can be configured to periodically transmit PATS 64 signals to the amplifier 46, which then broadcasts the PATS 64 signals, amplified within the 25 or 70.7 V_{RMS} full scale output limit of the audio amplifier 46, to the one or more AZRs 50. Each AZR 50 audio input includes the audio detector circuit 122, shown in FIG. 5, which can be periodically interrogated by the onboard microcontroller 74, shown in FIG. 3, and subjected to a polled inquiry by MEDI 32.

The audio detector circuit 122 in FIG. 5 uses an optoisolator 124 that is caused to conduct by the presence of either or both of an audio signal from the amplifier 46 and the PATS 64 signal. Connected to the output transistor side 126 of the optoisolator 124 is an RC network 128 that charges rapidly during an incoming audio or PATS 64 signal that exceeds an internal threshold indicating the presence of a signal, and discharges more slowly, such as at a rate requiring approximately thirty seconds to pass below the threshold, after the signal ends. A thirty-second discharge rate can ensure that PATS 64 signal audio detection circuits 122 in multiple AZRs 50 remain charged while MEDI 32 issues poll inquiries to as many as sixty-four addresses, sufficient for a maximized system. In a preferred embodiment, MEDI software 32 polls an entire system once per minute, so transmission of PATS 64 every fifteen seconds, for example, with sufficient energy to provide a thirty-second sag interval, substantially prevents false indications of system signal loss. The detector circuit 122 in the embodiment shown can be disabled by installing a link bridging the terminals of J1 130, so that the AC_SUPRV signal 132 remains high despite having no applied signal.

In the embodiment shown, the AC_SUPRV signal 132 is applied to a digital input 78 of the microcontroller 74, shown in FIG. 3. The logic level sense threshold for the microcontroller 74 is thus a criterion, along with the charge/discharge properties of the audio detection circuit 122, in the detection timing of the embodiment. In other embodiments, the AC_SUPRV signal 132 can, for example, be fed into the multiplexer 76, filtered, digitized by the microcontroller 74, and then compared to a fixed or programmable reference value. The latter configuration, another configuration such as one in which an analog comparator external to the microcontroller is used, or another level detection configuration, may be preferred in some embodiments.

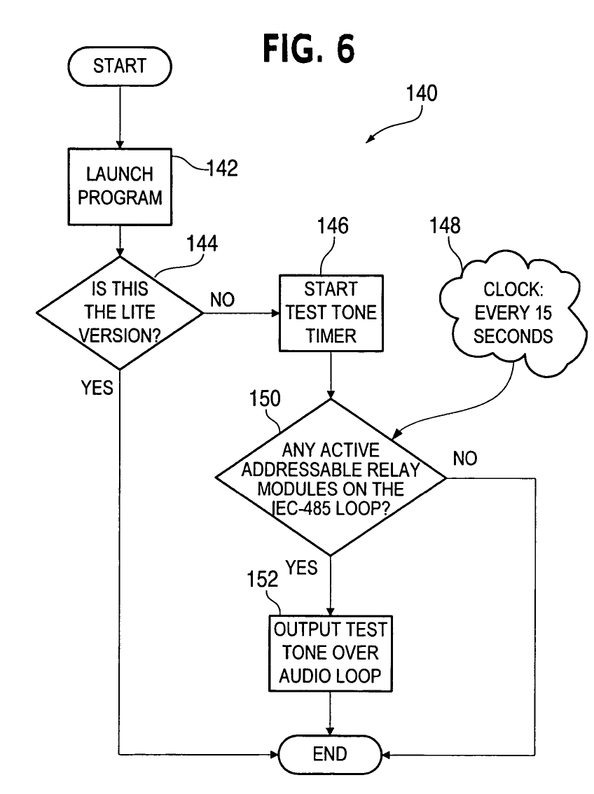

FIG. 6 shows an overview flowchart 140 in which the PATS 64 function has been added to MEDI 32. The flowchart shows initialization 142 of the system, and, since the MEDI software 32 continues to support operation of systems in which no AZR devices 50 are installed, there is an option 144 to inhibit PATS 64 from executing. If PATS 64 is to be used, then an additional interrupt generator is initialized 146, after which periodic PATS interrupts can occur 148. The PATS 64 interrupt rate in the embodiment shown is once per fifteen seconds. This is a plausible rate for a system in which the MEDI 32 polling rate is sixty seconds, since this rate allows a variety of synchronous and asynchronous events to take place with minimal risk that a logic state representing a properly detected PATS signal 64 will be lost before the next MEDI 32 polling cycle. A system having AZR devices 150 receives a command at each interrupt 148 to perform a PATS test transmission 152.

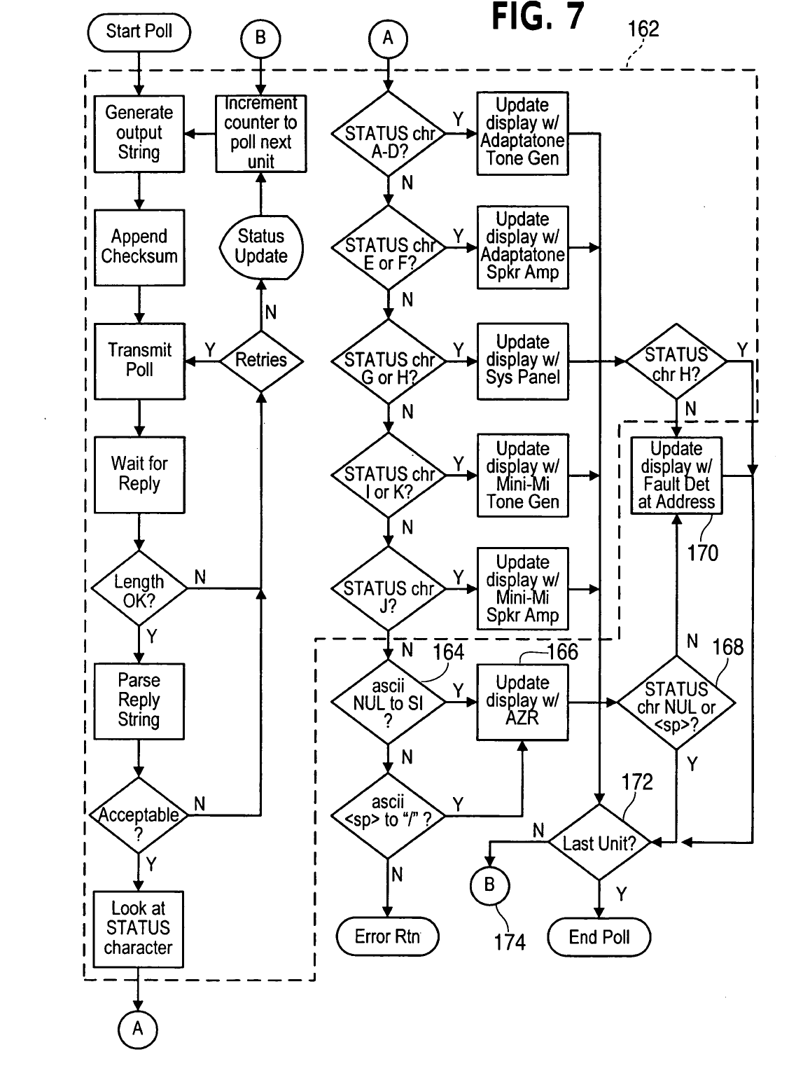

FIG. 7 shows in a flowchart 160 an embodiment of the polling routine of MEDI software, including possible responses from an AZR. A STATUS character is a single eight-bit field returned within a response string by a polled unit. The STATUS character includes unit type as well as condition.

In some embodiments, a unit response string after polling can employ the following format:
<STX><Unit Addr><43><STATUS><ZONE><ACK><ETX><CHKSUM>
Where
   <STX>=“start of transmission” character
   <Unit Addr>=hex representation of the address of the unit being polled, and ranges from 00 to 3F
   <43>=hex representation of “poll command confirmation”
   <STATUS>=unit information, including unit type, plus any fault conditions.
   <ZONE>=hex representation of unit zone assignment
   <ACK>=unit being polled acknowledges poll command and is responding appropriately
   <ETX>=“end of transmission” character
   <CHKSUM>=return string checksum

The STATUS character for any polled unit in a MEDI-controlled system, such as an AZR 50, originates from an eight-bit word within the unit, wherein each bit represents a datum. Not all characters returned are displayable, but all are readable by MEDI software 32. The bits defined in a preferred AZR 50 embodiment indicate the following:
Relay currently active
Trouble at Output Relay 1
Trouble at Output Relay 2
Amplifier Trouble (PATS and/or audible audio not reaching the input of the AZR)
Power Failure (operation on Battery Backup)
Reserved and unused bits

The AZR builds a single eight-bit character and includes the character as the STATUS character within the return string of a poll command.

In the embodiment shown in FIG. 7, polling 162 by MEDI, shown in the figure within a dashed box, is substantially unchanged from U.S. patent application Ser. No. 10/664,911. Polling 162 proceeds as the polling would in a system prior to PATS 64, except that replies from AZRs 164 are accommodated. When necessary, MEDI updates the display 166 by adding an AZR icon with an associated unit address. Unless one of the two “no trouble” messages is present 168, MEDI indicates a fault on the display 170, including the specific fault detected and the address. Unless this is the last unit 172, the process then loops back to reenter MEDI 174 and continue polling, including verification of the integrity of each AZR 50.

As discussed above, AZR 50 integrity data includes the state of the PATS signal detector circuit 120, shown in FIG. 5, the state of the output load circuits 80, shown in FIG. 4, the current operating mode of the output relays 84 and 86, and whether the AZR 50 has dropped back to battery backup (note that an AZR 50 not receiving power from a premises power source and lacking a usable battery would not have sufficient power to reply to the poll on the embodiment shown). AZR output relays 84 and 86, respectively, shown in FIG. 4, are activated periodically to their output-blocking state, so that the speaker strings 60 and 62, respectively, in FIG. 2, with their R_{EOL} terminations 26, can be multiplexed and tested for analog levels within an AZR 50 under test. In some embodiments, battery backup may not be provided, each AZR 50 may perform periodic self-test of the speakers 20 and output load resistors R_{EOL} 26 autonomously, the relays 84 and 86 may be restricted to actuating simultaneously and/or being assigned to the same zone, or additional functions may be performed and reported by an AZR 50. Similarly, the order of integrity data bits and the assignment of any “reserved” bits may be left to user discretion. Where desired, the MEDI polling response message can have a STATUS section with more bits.

If a scheduled event such as an audible tone or a voice message occurs during a PATS transmission 64 or a poll command 162, the activities can occur simultaneously, since the PATS 64 signal can be inaudible, the poll command 162 uses the IEC-485 lines, and the scheduled events are assigned to the audio lines.

The many features and advantages of the invention are apparent from the detailed specification, and, thus, it is intended by the appended claims to cover all such features and advantages of the invention that fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, that fall within the scope of the invention.

What is claimed is:

1. An apparatus for generating audible signals from at least one audio transducer, comprising:
an electrical load that comprises at least one audio transducer;
an audio amplifier configured to supply electrical signals having sufficient power to energize the audio transducer;
an addressable zone relay configured to control passage of audio information signals from the audio amplifier to the electrical load;
an audio control subsystem configured to provide audio signals to the audio amplifier, and further configured to provide bidirectional control communication to and from the addressable zone relay;
an audio control subsystem user interface configured to accept commands from a user and further configured to present system status information to a user; and
a system monitor function whereby amplifier operability and audio transducer integrity verification functions are performed and presented as components of the system status information.

2. The apparatus of claim 1, further comprising:
a first signal distribution subsystem whereby low-power audio signals are provided from the audio control subsystem to the audio amplifier;
a second signal distribution subsystem whereby high-power audio signals are provided from the audio amplifier to the addressable zone relay; and
a third signal distribution subsystem whereby high-power audio signals are provided from the addressable zone relay to the electrical load.

3. The apparatus of claim 2, further comprising:
an electronically generated test signal originating within the system monitor function and configured for amplification and distribution using the first, second, and third distribution subsystems, audio control subsystem, the audio amplifier, and the addressable zone relay.

4. The apparatus of claim 3, wherein the test signal further comprises:
a periodic waveform, substantially continuous over an interval, wherein the waveform has a fundamental frequency higher than a nominal audible frequency range for human hearing; and has a signal envelope, wherein:
the waveform in a first portion of the envelope rises in amplitude from an effectively zero initial amplitude to a full amplitude at a rate sufficiently gradual to generally prevent the at least one audio transducer from emitting an audible transient sound during application of the first portion of the envelope; wherein:
the waveform in a second portion of the envelope is substantially continuous with the waveform in the first portion and is substantially unchanging in amplitude; and wherein:
the waveform in a third portion of the envelope is substantially continuous with the waveform in the second portion and decreases in amplitude substantially continuously from full amplitude to an effectively zero final amplitude at a rate sufficiently gradual to generally prevent the at least one audio transducer from emitting an audible transient sound due to voltage transition both during and after application of the third portion of the envelope.

5. The apparatus of claim 4, wherein the addressable zone relay further comprises:
an input signal integrity detector, further comprising:
an input monitor, whereby an audio signal propagated from the audio amplifier generates an input status signal isolated at least in part from the audio signal;
an input status signal conditioner, whereby the signal properties of the isolated input status signal are scaled for sensing; and
an input status signal detector, whereby the scaled input status signal is evaluated for input operability;
a load integrity detector, further comprising:
a path switching function whereby the third signal distribution subsystem is disconnected from a signal path by which signals are otherwise presented thereto from the second signal distribution subsystem;
a load integrity test circuit, whereby a load integrity test signal is applied to the third signal distribution subsystem; and
a load integrity sense circuit, whereby the load integrity test signal is evaluated for load operability; and
an addressable zone relay status report generator, whereby the addressable zone relay responds to a status request communication from the audio control subsystem by transmitting a status reply communication.

6. The apparatus of claim 5, wherein the addressable zone relay further comprises:
an audio input signal interconnection provision;
an audio signal path continuity switching device;
an audio output signal interconnection provision;
an audio input signal detector;
an audio signal path electrical load test excitation circuit;
a control signal path message input detector;
a control processor; and
a control signal path output message transmitter.

7. The apparatus of claim 6, wherein the system monitor function further comprises:
a status inquiry generator whereby at least one information request is transmitted to at least one individual functional device;
a status response processor whereby at least one information reply from at least one individual functional device is parsed for device status content; and
a display whereupon at least one status element associated with operability of at least one individual functional device is presented.

8. A method for generating audible signals from at least one audio transducer, comprising:
generating at least one alternating-current electrical signal for informational message output, wherein the signal includes energy content in an audible frequency range;
sensing electrical signal activity, whereby operability of an informational message signal source is confirmed; and
redirecting an interconnection path that routes to an audio transducer load a signal, sourced from an amplifier, substituting therefor a test circuit, whereby a load status electrical state is determined at least in part by confirmation of a condition of electrical integrity of the path and the load.

9. The method for generating audible signals from at least one audio transducer of claim 8, further comprising:
polling a redirecting apparatus from a system monitor, using at least one system monitor status inquiry;
replying to the system monitor status inquiry from the redirecting device with at least one status report, wherein the status report includes at least one of an activity indication status indication and a load status indication;
monitoring system functions; and
displaying a system function monitor status.

10. The method for generating audible signals from at least one audio transducer of claim 9, further comprising:
generating at least one ultrasonic electrical test signal;
sensing an ultrasonic electrical test signal, whereby operability of an ultrasonic signal source is confirmed;
amplifying electrical signals within a frequency range including audio and ultrasonic frequencies to a level sufficient for driving at least one audio transducer; and
routing a plurality of amplified electrical signals to at least one audio transducer.

11. The method for generating audible signals from at least one audio transducer of claim 10, wherein generating at least one ultrasonic electrical test signal further comprises:
defining a periodic electrical signal waveform having a fundamental frequency higher than a nominal audible frequency range for human hearing;
defining an amplitude envelope wherein the waveform increases from an effectively zero initial amplitude to a maximum amplitude, continues without significant amplitude variation for an interval, and decreases from maximum to an effectively zero final amplitude, whereby a signal having the defined waveform and envelope is substantially inaudible when applied to an audio transducer at an electrical signal level at which an audio-frequency signal applied to the audio transducer is audible;
generating a data file configured for application of the waveform and amplitude envelope to an audio function of a computing device; and
applying the data file to the computing device audio function, whereby an ultrasonic electrical test signal is emitted.

12. The method for generating audible signals from at least one audio transducer of claim 11, wherein sensing electrical signal activity further comprises:
providing a two-conductor signal path from an input port for amplifier electrical signals to an output port for the audio transducer load, wherein at least one of the conductors is not an electrical return;
configuring an activity detector across the provided two-conductor signal path, whereby an alternating-current electrical signal present on the signal path with an amplitude exceeding a threshold amplitude generates an activity indication signal;
conditioning the activity indication signal for incorporation into at least one activity indication and load status report; and
reporting at least one activity indication status result to the system monitor.

13. The method for generating audible signals from at least one audio transducer of claim 12, wherein displaying a system function monitor status further comprises:
polling a plurality of system devices from a system monitor;
compiling system device status for the plurality of system devices;
configuring a display controlled by the system monitor for presentation of system device status;
presenting on the display a representation of status for each system device of the plurality of system devices; and
announcing fault events by at least one of a text representation, a graphical representation, an enhanced graphical indication, and an audible signal.

14. The method for generating audible signals from at least one audio transducer of claim 10, wherein monitoring system functions further comprises:
configuring an load test excitation signal, wherein a power source presents a voltage, regulated at least in part with reference to an electrical return, for application to the first output electrical signal line;
configuring a load test electrical load, wherein the second output load electrical signal line is routed via a voltage scaling circuit to the electrical return, whereby a load test output signal is developed, wherein the load test output signal correlates to load status;
switching a relay from a first state, wherein the relay routes a first and a second input electrical signal lines from an amplifier to a first and a second output load electrical signal lines, to a second state, wherein the relay routes the excitation and the return test signal lines to the first and the second output load electrical signal lines;
performing signal processing upon the load test output signal, wherein the signal processing produces a load status result, wherein the signal processing comprises at least one of analog multiplexing, amplifying, filtering, analog-to-digital conversion, threshold detecting, and load test result storage;
conditioning the load status result for incorporation into at least one activity indication and load status report; and
reporting at least one load status result to the system monitor.

15. An apparatus for generating audible signals from at least one audio transducer, comprising:
means for generating at least one alternating-current electrical signal for informational message output, wherein the means for generating furnishes energy content in an audible frequency range;
means for sensing electrical signal activity, whereby operability of the means for generating is confirmed;
means for transducing an electrical signal into an audio signal, whereby information is broadcast;
means for testing the means for transducing; and
means for redirecting an interconnection path that routes to the means for transducing a signal, sourced from the means for generating, substituting therefor the means for testing, whereby a load status electrical state is determined at least in part by confirmation of a condition of electrical integrity of the interconnection path and the means for transducing.

16. The apparatus for generating audible signals from at least one means for transducing of claim 15, further comprising:
means for monitoring system functions;
means for polling a means for redirecting from a means for monitoring, using at least one system monitor status inquiry;
means for replying to the status inquiry from the means for redirecting with at least one status report, wherein the status report includes at least one of an activity indication status indication and a load status indication;
means for displaying a system status.

17. The apparatus for generating audible signals from at least one means for transducing of claim 16, further comprising:
means for generating at least one ultrasonic electrical test signal;
means for sensing an ultrasonic electrical test signal, whereby operability of the means for generating ultrasonic signals is confirmed;
means for amplifying electrical signals within a frequency range including audio and ultrasonic frequencies to a level sufficient for driving at least one means for transducing; and
means for routing a plurality of amplified electrical signals to at least one means for transducing.

18. The apparatus for generating audible signals from at least one means for transducing of claim 17, wherein the means for generating at least one ultrasonic electrical test signal further comprises:
means for defining a periodic electrical signal waveform having a fundamental frequency higher than a nominal audible frequency range for human hearing;
means for defining an amplitude envelope wherein the waveform increases from an effectively zero initial amplitude to a maximum amplitude, continues without significant amplitude variation for an interval, and decreases from maximum to an effectively zero final amplitude, whereby a signal having the waveform and envelope defined by the means for defining is substantially inaudible when applied to the means for transducing at an electrical signal level at which an audio-frequency signal applied to the means for transducing is audible;
means for generating a data file configured for application of the waveform and amplitude envelope to an audio function of a computing device; and
means for applying the data file to the computing device audio function, whereby an ultrasonic electrical test signal is emitted.

19. The apparatus for generating audible signals from at least one means for transducing of claim 18, wherein the means for sensing electrical signal activity further comprises:
means for providing a two-conductor signal path from an input port for amplifier electrical signals to an output port for the audio transducer load, wherein at least one of the conductors is not an electrical return;
means for configuring an activity detector across the provided two-conductor signal path, whereby an alternating-current electrical signal present on the signal path with an amplitude exceeding a threshold amplitude generates an activity indication signal;
means for conditioning the activity indication signal for incorporation into at least one activity indication and load status report; and
means for reporting at least one activity indication status result to the means for monitoring.

20. The apparatus for generating audible signals from at least one means for transducing of claim 17, wherein the means for monitoring system functions further comprises:
means for exciting a load with a test signal, wherein a means for sourcing power presents a voltage, regulated at least in part with reference to an electrical return, for application to the first output electrical signal line;
means for configuring a load test electrical load, wherein the second output load electrical signal line is routed via a voltage scaling circuit to the electrical return, whereby a load test output signal is developed, wherein the load test output signal correlates to load status;
means for switching a relay from a first state, wherein the relay routes a first and a second input electrical signal lines from the means for amplifying to a first and a second output load electrical signal lines, to a second state, wherein the relay routes a means for exciting and a means for return test signal line to the first and the second output load electrical signal lines;
means for processing the load test output signal, wherein the means for processing produces a load status result, wherein the means for processing comprises at least one of analog multiplexing, amplifying, filtering, analog-to-digital conversion, threshold detecting, and load test result storage;
means for conditioning the load status result for incorporation into at least one activity indication and load status report; and
means for reporting at least one load status result to the means for monitoring.

21. The apparatus for generating audible signals from at least one means for transducing of claim 20, wherein the means for displaying monitoring system functions further comprises:
means for polling a plurality of system devices from a means for monitoring;
means for compiling system device status for the plurality of system devices;
means for configuring a means for displaying, controlled by the means for monitoring, for presentation of system device status;
means for presenting on the means for displaying a representation of status for each system device of the plurality of system devices; and
means for announcing fault events by at least one of a text representation, a graphical representation, an enhanced graphical indication, and an audible signal.
